(19) United States
(12) Patent Application Publication
(10) Pub. No.: US 2007/0261637 A1
(43) Pub. Date: Nov. 15, 2007

(54) Portable wallpaper dispenser device

(76) Inventor: Joseph Manfredi, Westerly, RI (US)

Correspondence Address: Bruce Tedeschi;Rakosky, Haviland & Tedeschi, PC, 71 Granite Street, New London, CT, 06320, US

(21) Appl. No.: 11/431,071

(22) Filed: May 10, 2006

(51) Int. Cl. B05C 3/12

(52) U.S. Cl. 118/419; 118/428; 118/429

(57) ABSTRACT

The invention relates to a portable wallpaper applicator for easily wetting and dispensing fixed lengths of pre-pasted wallpaper. The device is characterized by a single pan into which a movable hinged roller can be easily rotated for wetting wallpaper and an angled cover for easy drawing of the wetted wallpaper. The apparatus is meant to be constructed from lightweight materials (particularly plastic or polystyrene) such that it can be easily transported and used by a single individual. A second embodiment of the portable device includes a counter that gives a read-out of the length of wallpaper and a sliding cutter member for cutting defined lengths of wallpaper.

### BACKGROUND

The present invention relates to an improved portable apparatus that wets, dispenses, and measures pre-pasted lengths of wallpaper while minimizing interaction of water and paste with a user's hands. The apparatus is characterized by a single tray into which a movable hinged roller can be easily rotated for wetting wallpaper, without the need to put hands in water, and an angled sidewall for easy drawing of the wetted wallpaper. A preferred embodiment of the portable apparatus device includes a meter that gives a read-out of the amount of wallpaper drawn from the tray. The apparatus is meant to be constructed from lightweight materials (particularly plastic or polystyrene) with a carrying handle and cover such that it can be easily transported and used by a single individual.

The prior art discloses devices that mimic some of the features in the current invention but no previous device includes all the elements that allow for a portable apparatus that easily wets, measures and dispenses pre-pasted wallpaper while minimizing interaction of water and paste with a user's hands.

U.S. Pat. No. 4,244,320 discloses a wallpaper trough assembly made from lightweight polystyrene housing a simple rod for dispensing the wallpaper. Although lightweight and simple, the rod cannot be rotated in-and-out of the trough for ease of use, no counting device exists for the measurement of wallpaper, and no carrying means are described.

U.S. Pat. No. 4,934,311 discloses a wallpaper water trough assembly containing several movable rods for wetting and dispensing wallpaper. The apparatus does not disclose one simple rotable rod for ease of use, no counting device, and no carrying means.

U.S. Pat. No. 5,050,529 discloses a portable chamber for wetting, measuring, cutting and holding cut wallpaper sections. However, the apparatus requires movement of wallpaper through three separate trough areas and does not provide for an rotatable hinged roller.

U.S. Pat. Nos. 6,540,834 B2 and 6,835,249 B1 disclose a wallpaper dispensing apparatus that is uniquely adapted to uniformly wet a strip of wallpaper. The apparatus does not disclose the portability and ease of use features described in the present invention.

### SUMMARY OF THE INVENTION

It is therefore an object of the invention to disclose an improved wallpaper wetting and dispensing apparatus.

It is another object of the invention to disclose an improved wallpaper wetting and dispensing apparatus that is lightweight, economical to manufacture, and easy to carry.

It is another object of the invention to disclose an improved wallpaper wetting and dispensing apparatus that is easy to use while minimizing interaction of water and paste with a user's hands.

It is another object of the invention to disclose an improved wallpaper wetting and dispensing apparatus that provides all of the foregoing capabilities and can also measure and cut the wetted strips of wallpaper.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a perspective view illustrating an improved portable wallpaper wetting and dispensing device in accordance with an exemplary embodiment of the present invention:

FIG. 2 is the same view as FIG. 1 with the optional cover in the open position and the arms positioned up and above the top of the pan;

FIG. 3 is the same view as FIG. 2 with the arms positioned down into the pan;

FIG. 4 is a cross-sectional view of FIG. 3;

FIG. 5 is a similar view as FIG. 2 showing a second embodiment that allows for a paper length counter, paper guide, and paper cutter.

### DETAILED DESCRIPTION OF THE INVENTION

Reference will now be made in detail to the presently preferred embodiments of the invention, examples of which are illustrated in the accompanying drawings.

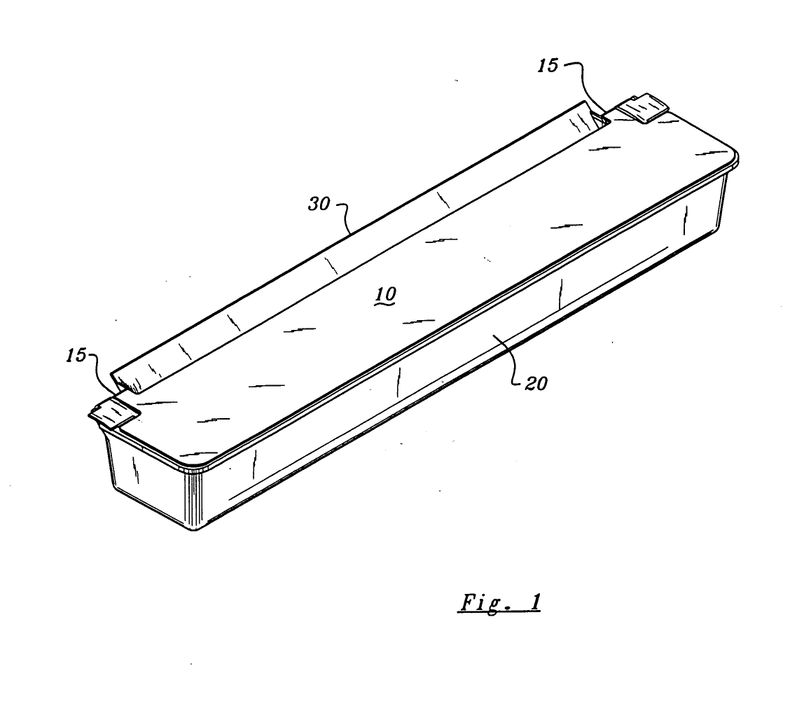

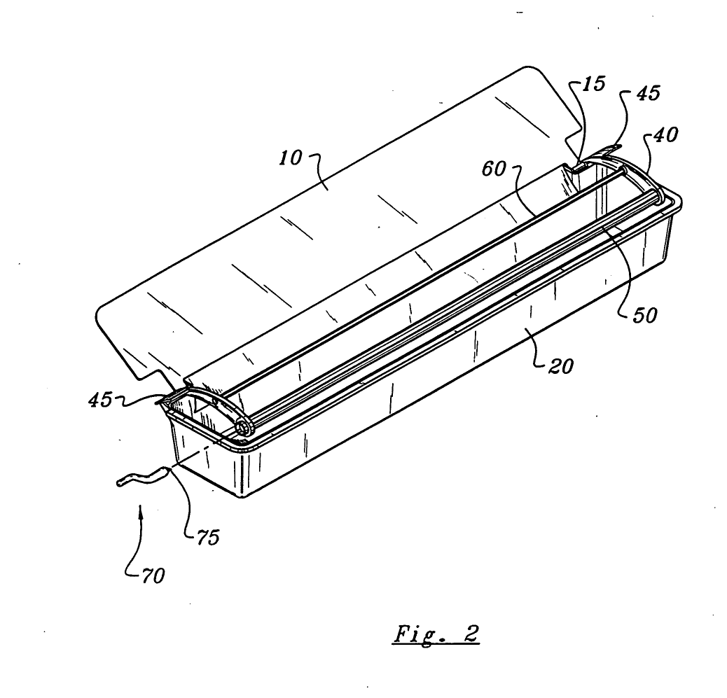

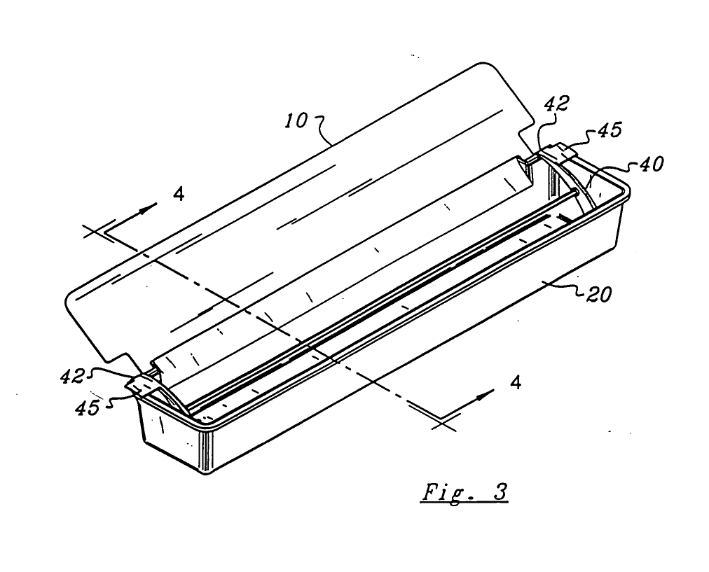

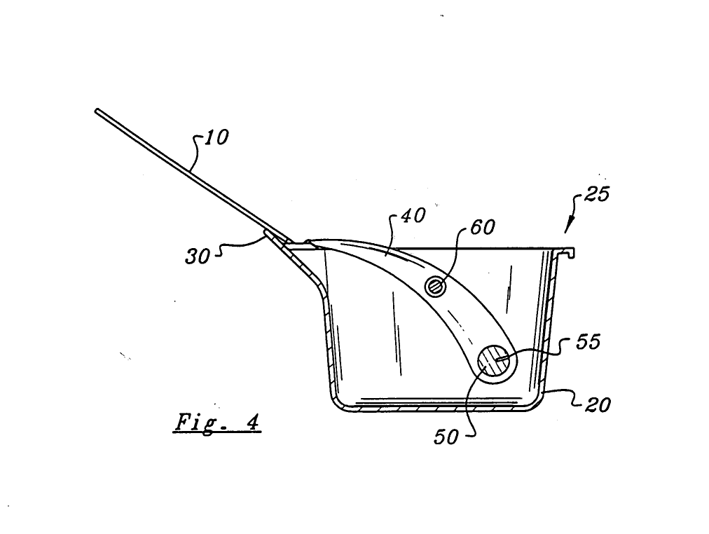

Referring to FIGS. 1, 2, 3, and 4 for one embodiment, the device includes a hinged cover 10 and pan 20. Although the invention assumes construction of the device using polystyrene, other lightweight materials may be used. The pan holds water for wetting the pre-pasted wallpaper. Preferably, the pan has a molded back edge 30 that stops the cover at a fixed angled. At this angle the wetted paper can be pulled across the surface of angled cover. With reference to FIG. 2 or FIG. 4, the sheet or roll of wallpaper is held by a detachable take-up roller 50. Preferably, the roller has a longitudinal slot 55 to firmly hold the wallpaper to the roller. The paper can be rolled on and off the roller by way of a crank 70 that interfaces 75 with the roller. The crank is not necessary but it offers a mechanical advantage while also allowing minimal manual interaction with the paper, thereby helping to keep hands/fingers relatively dry and free of paste. The roller is connected at each end by lever arms 40. The arms can be readily moved up and down via a hinge element 42 connected to the rear wall of the pan. The movement of the arms down into the pan allow the pre-pasted wallpaper to be wetted. A rod element 60 aids in keeping the arms stable. At the region of each lever arm, adjacent to its connection to the hinge, the arm displays a flat and broad thumb grip 45 to facilitate manual movement of the lever arms out of (FIG. 2) and into (FIG. 3) the pan. Although the thumb grips are not necessary, they offer a facile way of moving the lever arms in a manner that helps to keep hands/fingers relatively dry and free of paste. Finally, the invention features a drain lip 25 to allow water flow back into the bottom of the pan.

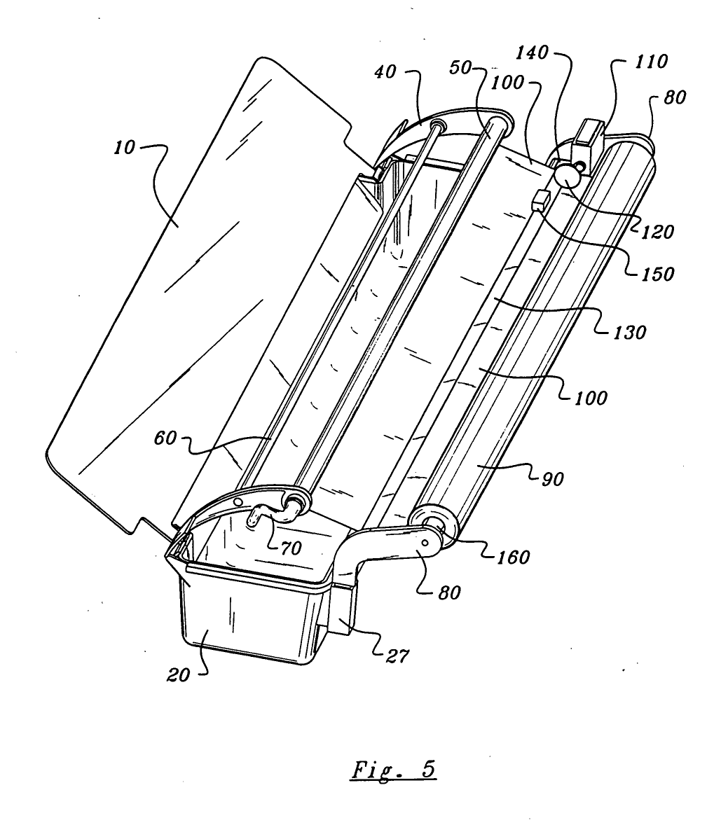

FIG. 5 shows a second embodiment of the invention. The embodiment features modifications or additions to the first embodiment that allow for cutting of specific lengths of wallpaper. A second paper roller 80, containing a shaft 160 for holding the wallpaper 90, is attached by way of a boss 27 to the long side of the pan surface away from the pan surface by which the lever arms are hinged. The wallpaper is rolled through an upper paper guide 130 and lower paper guide 140 as it passes across a counter wheel 120 that controls the length counter 110. The lower paper guide provides surface for the counter wheel to push against and maintain contact with the wallpaper. Finally, the measured length of paper is cut by sliding the paper cutter 150 across the upper paper guide.

Although the preferred embodiments of this invention have been described in detail by way of illustration for purposes of understanding the device, it is understood that various modifications and changes may be made within the scope of the following claims without departing from the essence and material advantages of the invention.

I claim:

1. An improved wallpaper wetting an dispensing devise, comprising:
a. A preformed pan having an attachable cover that can be adjusted at an angle to serve as a surface for drawing wet wallpaper from the pan, forward and rearward walls, opposing side walls, and a bottom with a length dimension to accommodate the standard length of a roll of wallpaper and a depth dimension to allow a wetting substance to completely cover a roll or strip of wallpaper; and
b. A roller connected to the backward wall of the pan by movable arms hinged to the back wall of the pan such that the roller can be rotated via the arms from an elevation above the top of the pan to a position inside the pan.

2. An apparatus according to claim 1 further comprising a crank at one end of the roller wherein the roller can be manually rotated at the connecting arms.

3. An apparatus according to claim 1 further comprising a second paper roller wherein the paper from the second roller first passes across a counter wheel member wherein said wheel member is mounted along the outside of the forward tray wall such that when wallpaper is pulled over said wheel member a counter is activated to determine the length of said wallpaper passing over said wheel member and wherein the paper can then be cut by passing across a sliding cutting member.

4. An apparatus according to claim 2 further comprising a second paper roller wherein the paper from the second roller first passes across a counter wheel member wherein said wheel member is mounted along the outside of the forward tray wall such that when wallpaper is pulled over said wheel member a counter is activated to determine the length of said wallpaper passing over said wheel member and wherein the paper can then be cut by passing across a sliding cutting member.
